(19) United States
(12) Patent Application Publication
(10) Pub. No.: US 2020/0334781 A1
(43) Pub. Date: Oct. 22, 2020

(54) SYSTEMS AND METHODS FOR RECOMMENDING TRAVEL SERVICES

(71) Applicant: BEIJING DIDI INFINITY TECHNOLOGY AND DEVELOPMENT CO., LTD., Beijing (CN)

(72) Inventors: Jun XIAO, Beijing (CN); Nan YANG, Beijing (CN); Xinrui LI, Beijing (CN)

(73) Assignee: BEIJING DIDI INFINITY TECHNOLOGY AND DEVELOPMENT CO., LTD., Beijing (CN)

(21) Appl. No.: 16/917,855

(22) Filed: Jun. 30, 2020

Related U.S. Application Data
(63) Continuation of application No. PCT/CN2019/084754, filed on Apr. 28, 2019.

(30) Foreign Application Priority Data
May 2, 2018 (CN) 201810409685.3

(51) Int. Cl. G06Q 50/30; G06Q 30/06

(52) U.S. Cl. CPC G06Q 50/30; G06Q 30/0631

(57) ABSTRACT

The present disclosure relates to a system and method for recommending travel services to a user. The method comprises obtaining a current real-time location and a preset area centered around the current real-time location. The method also comprises determining a current real-time transport capacity status of the preset area at the current real-time. The method further comprises comparing the current real-time transport capacity status with a threshold value. The method still further comprises if the current real-time transport capacity status is not larger than the threshold value, obtaining a first data set related to service orders that were placed in a first preset time period in the preset area and a second data set related to service orders placed by the user during a second preset time period, and generating a travel service recommendation for the user based on the first and the second data sets.

### CROSS-REFERENCE TO RELATED APPLICATIONS

This application is a continuation of International Patent Application No. PCT/CN2019/084754, filed on Apr. 28, 2019, which claims priority to Chinese Patent Application No. 201810409685.3 filed on May 2, 2018, the contents of which are hereby incorporated by reference.

### TECHNICAL FIELD

The present disclosure generally relates to on-line services, and more particularly, relates to systems and methods for recommending travel services in an on-line service.

### BACKGROUND

The rapid development of mobile Internet has brought great changes to people's life. People have become more and more accustomed to using a car-hailing app (application) to select an appropriate travel service. During this process, a user may input relevant information such as a start location, an end location, and a departure time through a terminal to place a travel order. A driver who uses the car-hailing app determines whether to accept the order based on the information of the travel order. If the driver accepts the order, he/she picks up the passengers at the start location, and starts the travel. However, with the increasing of drivers and passengers using the car-hailing app, it is possible that there will be insufficient transport capacity in a certain area during high peak travel hours. In the prior art, the car-hailing app usually solves the problem of insufficient transport capacity by adjusting the order price during high peak travel hours dynamically. However, the method in the prior art allocates the transport capacity during high peak travel hours passively, and has a low flexibility. Thus, it is desirable for a system and a method for recommending travel services so as to alleviate insufficient transport capacity.

### SUMMARY

According to an aspect of the present disclosure, a method implemented on a device having a processor and a computer-readable storage medium for recommending travel services to a user may be provided. The method may comprises obtaining and storing in the device, a current real-time location of the user and a preset area centered around the current real-time location of the user; determining and storing in the device, a current real-time transport capacity status of the preset area at the current real-time; using the processor to compare the current real-time transport capacity status of the preset area with a threshold value; if the current real-time transport capacity status of the preset area is not larger than the threshold value, obtaining and storing in the device, a first data set related to service orders that were placed in a first preset time period in the preset area and a second data set related to service orders placed by the user during a second preset time period and using the processor to generate a travel service recommendation for the user based on the first and the second data sets.

In some embodiments, the method further comprises transmitting the travel service recommendation to a terminal device of the user.

In some embodiments, the second data set comprises at least one of pick up location, departure time, trip duration, destination location, or travel mode of each service order.

In some embodiments, the first preset time period and the second preset time period at least partially overlap with each other.

In some embodiments, the first preset time period and the second preset time period do not overlap with each other.

In some embodiments, the current real-time transport capacity status of the preset area is determined according to a ratio of the number of service requests placed to the number of available service providers in the preset area at the current real-time or a difference between the number of service requests placed and the number of available service providers in the preset area at the current real-time.

In some embodiments, generating the travel service recommendation based on the first and the second data sets comprises determining a travel habit of the user based on the second data set, determining low peak travel hours in the preset area based on the first data set, and generating the travel service recommendation based on the travel habit of the user and the low peak travel hours in the preset area.

In some embodiments, the travel habit of the user comprises at least one of an itinerary of the user with a highest frequency of travel or routine itineraries of the user during the second preset time period.

In some embodiments, the travel service recommendation comprises at least one of a discount when the travel habit of the user matches the low peak travel hours in the preset area, a discount when a currently requested itinerary of the user matches the low peak travel hours, or a recommended new pick up location that is in a preset range from the currently requested pick up location of the user when a transport capacity status of a new preset area centering around the recommended new pick up location satisfies a preset condition.

In some embodiments, the method further includes providing a user interface for reserving a travel service in which the discount can be applied based on the travel service recommendation.

According to another aspect of the present disclosure, a system for recommending travel services to a user may be provided. The system may comprises at least one storage medium including a set of instructions; and at least one processor configured to communicate with the at least one storage medium, wherein when executing the set of instructions, the at least one processor is directed to obtain and store in the storage medium, a current real-time location of the user and a preset area centered around the current real-time location of the user; determine and store in the storage medium, a current real-time transport capacity status of the preset area at the current real-time; use the at least one processor to compare the current real-time transport capacity status of the preset area with a threshold value; if the current real-time transport capacity status of the preset area is not larger than the threshold value, obtain and store in the storage medium, a first data set related to service orders that were placed in a first preset time period in the preset area and a second data set related to service orders placed by the user during a second preset time period and use the at least one processor to generate a travel service recommendation for the user based on the first and the second data sets.

According to a further aspect of the present disclosure, a non-transitory computer readable medium is provided. The non-transitory computer readable medium may comprises at least one set of instructions for recommending travel services to a user, wherein when executed by at least one processor of a computing device, the at least one set of instructions causes the computing device to perform a method, the method comprising obtaining and storing in the device, a current real-time location of the user and a preset area centered around the current real-time location of the user; determining and storing in the device, a current real-time transport capacity status of the preset area at the current real-time; using the processor to compare the current real-time transport capacity status of the preset area with a threshold value; if the current real-time transport capacity status of the preset area is not larger than the threshold value, obtaining and storing in the device, a first data set related to service orders that were placed in a first preset time period in the preset area and a second data set related to service orders placed by the user during a second preset time period and using the processor to generate a travel service recommendation for the user based on the first and the second data sets.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary transportation recommendation system according to some embodiments of the present disclosure;

FIG. 2 is a schematic diagram illustrating exemplary components of a computing apparatus according to some embodiments of the present disclosure;

FIG. 3 is a schematic diagram illustrating exemplary hardware and/or software components of an exemplary user terminal according to some embodiments of the present disclosure;

FIG. 4 is a flowchart illustrating a process 400 for recommending travel services to a user according to some embodiments of the present disclosure;

FIG. 5 is a flowchart illustrating a process 500 for recommending travel services to a user according to some embodiments of the present disclosure;

FIG. 6 is a flowchart illustrating a process 600 for recommending travel services to a user according to some embodiments of the present disclosure;

FIG. 7 is a schematic diagram illustrating an exemplary user interface displaying a travel service recommendation of a discount which can be applied in a service order according to some embodiment of the present disclosure;

FIG. 8 is a schematic diagram illustrating an exemplary user interface for reserving a travel service in which a discount can be applied according to some embodiment of the present disclosure;

FIG. 9 is a schematic diagram illustrating an exemplary travel service recommendation device for recommending travel services for a user according to some embodiment of the present disclosure;

FIG. 10 is a schematic diagram illustrating an exemplary travel service recommendation device for recommending travel services for a user according to some embodiment of the present disclosure; and

FIG. 11 is a schematic diagram illustrating an exemplary device for recommending travel services for a user according to some embodiments of the present disclosure.

### DETAILED DESCRIPTION

In order to illustrate the technical solutions related to the embodiments of the present disclosure, brief introduction of the drawings referred to in the description of the embodiments is provided below. Obviously, drawings described below are only some examples or embodiments of the present disclosure. Those having ordinary skills in the art, without further creative efforts, may apply the present disclosure to other similar scenarios according to these drawings. Unless stated otherwise or obvious from the context, the same reference numeral in the drawings refers to the same structure and operation.

As used in the disclosure and the appended claims, the singular forms “a,” “an,” and “the” include plural referents unless the content clearly dictates otherwise. It will be further understood that the terms “comprises,” “comprising,” “includes,” and/or “including” when used in the disclosure, specify the presence of stated steps and elements, but do not preclude the presence or addition of one or more other steps and elements.

Some modules of the system may be referred to in various ways according to some embodiments of the present disclosure, however, any number of different modules may be used and operated in a client terminal and/or a server. These modules are intended to be illustrative, not intended to limit the scope of the present disclosure. Different modules may be used in different aspects of the system and method.

According to some embodiments of the present disclosure, flow charts are used to illustrate the operations performed by the system. It is to be expressly understood, the operations above or below may or may not be implemented in order. Conversely, the operations may be performed in inverted order, or simultaneously. Besides, one or more other operations may be added to the flowcharts, or one or more operations may be omitted from the flowchart.

Technical solutions of the embodiments of the present disclosure be described with reference to the drawings as described below. It is obvious that the described embodiments are not exhaustive and are not limiting. Other embodiments obtained, based on the embodiments set forth in the present disclosure, by those with ordinary skill in the art without any creative works are within the scope of the present disclosure.

Some embodiments of the present disclosure are directed to an on-line service prediction function applicable in, e.g., on-demand services, which is a newly emerged service or demand rooted only in the post-Internet era. It provides the technical solutions to customers that could rise only in the post-Internet era. In the pre-Internet era, it is impossible to predict types of services requested by users. Therefore, the present solution is deeply rooted in and aimed to solve a problem only occurred in the post-Internet era.

In one aspect, the present disclosure directs to a system and method for recommending travel services. The system may determine travel habits of a user and low peak travel hours in an area centering around the start location of the user, and recommend travel services to the user based on the travel habits and low peak travel hours in the area.

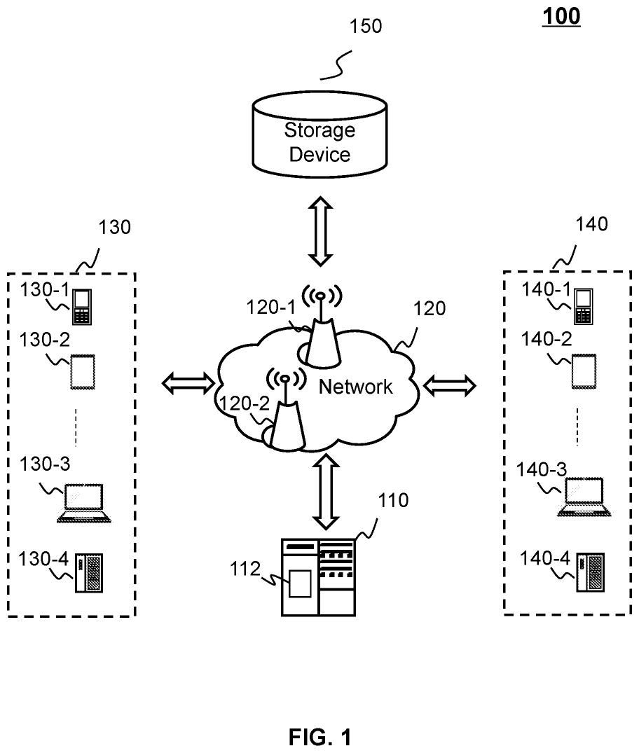

FIG. 1 illustrates an exemplary network environment of a travel service recommendation system according to some embodiments of the present disclosure. The travel service recommendation system 100 may be an online service platform for providing travelling related services. The travel service recommendation system 100 may include a server 110, a network 120, a user terminal 130, a driver device 140, and a storage device 150. In some embodiments, the travel service recommendation system 100 may further include a positioning device 160 (not shown in FIG. 1).

The travel service recommendation system 100 may be applicable in a plurality of travel services. Exemplary travel services may include a travel plan service, an on-demand service (e.g., a taxi hailing service, a chauffeur service, an express car service, a carpool service, a bus service, or a driver hire service), or the like, or a combination thereof.

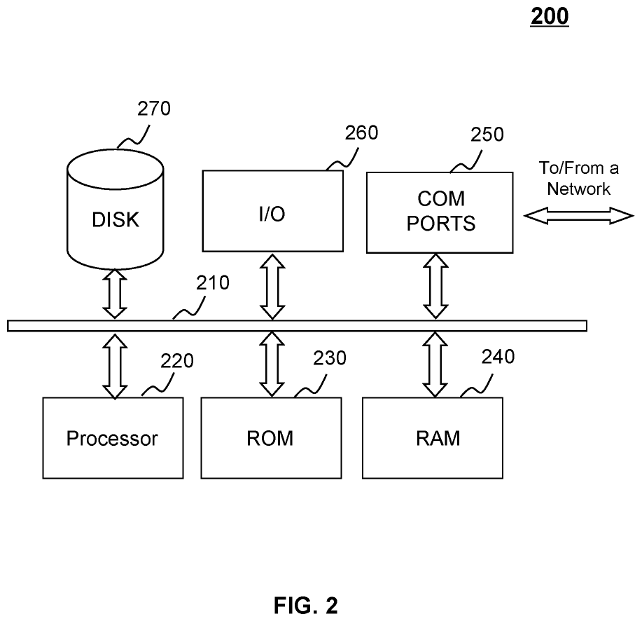

The server 110 may process data and/or information from one or more components of the travel service recommendation system 100 or an external data source (e.g., a cloud data center). The server 110 may communicate with the user terminal 130 and/or the driver device 140 to provide various functionality of online services. In some embodiments, the server 110 may be a single server, or a server group. The server group may be a centralized server group connected to the network 120 via an access point, or a distributed server group connected to the network 120 via one or more access points, respectively. In some embodiments, the server 110 may be locally connected to the network 120 or in remote connection with the network 120. For example, the server 110 may access information and/or data stored in the user terminal 130, the driver device 140, and/or the storage device 150 via the network 120. As another example, the storage device 150 may serve as backend data storage of the server 110. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented in a computing apparatus 200 having one or more components illustrated in FIG. 2 in the present disclosure.

In some embodiments, the server 110 may include a processing device 112. The processing device 112 may process information and/or data related to one or more functions described in the present disclosure. In some embodiments, the processing device 112 may perform main functions of the travel service recommendation system 100. For example, the processing device 112 may process information to recommend travel services for a passenger so as to alleviate insufficient transport capacity as well as improve travel efficiency. In some embodiments, the processing device 112 may perform other functions related to the method and system described in the present disclosure.

In some embodiments, the processing device 112 may include one or more processing units (e.g., single-core processing device(s) or multi-core processing device(s)). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the travel service recommendation system 100 (e.g., the server 110, the user terminal 130, the driver device 140, the storage device 150) may send information and/or data to other component(s) in the travel service recommendation system 100 via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the travel service recommendation system 100 may be connected to the network 120 to exchange data and/or information.

The user terminal 130 and/or the driver device 140 may communicate with the server 110 via the network 120. In some embodiments, a passenger (i.e., customer) may be an owner of the user terminal 130. In some embodiments, the owner of the user terminal 130 may be someone other than the passenger. For example, an owner A of the user terminal 130 may use the user terminal 130 to send a service request for a passenger B, and/or receive a service confirmation and/or information or instructions from the server 110. In some embodiments, a driver may be a user of the driver device 140. In some embodiments, the user of the driver device 140 may be someone other than the driver. For example, a user C of the driver device 140 may use the driver device 140 to receive a service request for a driver D, and/or information or instructions from the server 110. In some embodiments, a driver may be assigned to use one of the driver device 140 for at least a certain period of time. For example, when a driver is available to provide an on-demand service, he/she may be assigned to use a driver terminal that receives an earliest request and a vehicle that is recommended to perform the type of on-demand service. In some embodiments, “passenger”, “customer”, “user” and “user terminal ” may be used interchangeably.

A customer may receive a service response for a trip via the user terminal 130. In some embodiments, the user terminal 130 may obtain information of the trip from the processing device 112 via the network 120. The user terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, an Oculus Rift™, a Hololens™, a Gear VR™, etc. In some embodiments, a built-in device in the vehicle 130-4 may include a built-in computer, an onboard built-in television, a built-in tablet, etc. In some embodiments, the user terminal 130 may include a signal transmitter and a signal receiver configured to communicate with the positioning device 160 for locating the position of the passenger and/or the user terminal 130, and determining a relative distance from his/her position to a road.

The driver may receive a service request via the driver device 140. The driver device 140 may include a plurality of driver devices 140-1, 140-2, . . . , 140-n. In some embodiments, the driver device 140 may be similar to, or same as the user terminal 130. In some embodiments, the driver device 140 may be customized to implement online services based on related information obtained from the processing device 112.

The storage device 150 may store data and/or instructions. The data may include geographic location information, time information, driver information, customer information, external environment, or the like. Merely for illustration purposes, data related to geographic location information may include a service location (i.e., a departure location), an arrival location, a distance between the departure location and the arrival location, etc. Data related to time information may include a service time (i.e., a departure time), an order acceptance time, an order-complete time, etc. Data related to driver information may include a driver identification (ID), a user profile of the driver, an account of the driver, etc. In some embodiments, the storage device 150 may store data obtained from the user terminal 130 and/or the driver device 140. For example, the storage device 150 may store logs associated with the user terminal 130.

In some embodiments, the storage device 150 may store data and/or instructions that the processing device 112 may execute to recommend travel services for a customer as described in the present disclosure. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, one or more components in the travel service recommendation system 100 may access the data or instructions stored in the storage device 150 via the network 120. In some embodiments, the storage device 150 may be directly connected to the server 110 as a backend storage.

The positioning device 160 may determine information associated with an object, for example, one or more of the user terminal 130, the driver device 140, etc. For example, the positioning device 160 may determine a physical location (geographic location) of the user terminal 130. In some embodiments, the positioning device 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information provided by the positioning device 160 may include a location, an elevation, a velocity, or an acceleration of the object, and/or a current time. The location may be in the form of coordinates, such as, a latitude coordinate and a longitude coordinate, etc. The positioning device 160 may include or associate with one or more satellites. The satellites may determine the information mentioned above independently or jointly. The positioning device 160 may send the information mentioned above to the user terminal 130, or the driver device 140 via the network 120.

One of ordinary skill in the art would understand that when an element of the travel service recommendation system 100 performs, the element may perform through electrical signals and/or electromagnetic signals. For example, when a user terminal 130 processes a task, such as placing an order of a trip from one place to another, the user terminal 130 may operate logical circuits in its processor to process such task. When the user terminal 130 sends out an instruction to the server 110, a processor of the user terminal 130 may generate electrical signals encoding the instruction. The processor of the user terminal 130 may then send the electrical signals to an output port. If the user terminal 130 communicates with the server 110 via a wired network, the output port may be physically connected to a cable, which further transmit the electrical signal to an input port of the server 110. If the user terminal 130 communicates with the server 110 via a wireless network, the output port of the user terminal 130 may be one or more antennas, which convert the electrical signals to electromagnetic signals. Similarly, a driver device 140 may process a task through operation of logical circuits in its processor, and receive an instruction and/or information from the server 110 via electrical signals or electromagnet signals. Within an electronic device, such as the user terminal 130, the driver device 140, and/or the server 110, when a processor thereof processes an instruction, sends out an instruction, and/or performs an action, the instruction and/or action is conducted via electrical signals. For example, when the processor retrieves data from a storage medium (e.g., the storage device 150), it may send out electrical signals to a read device of the storage medium, which may read structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary components of a computing apparatus according to some embodiments of the present disclosure. The server 110, the user terminal 130, and/or the driver device 140, the storage device 150 may be implemented on the computing apparatus 200 according to some embodiments of the present disclosure. The particular system may use a functional block diagram to explain the hardware platform containing one or more user interfaces. The computer may be a computer with general or specific functions. Both types of the computers may be configured to implement any particular system according to some embodiments of the present disclosure. Computing apparatus 200 may be configured to implement any components that perform one or more functions disclosed in the present disclosure. For example, the computing apparatus 200 may implement any component of the travel service recommendation system 100 as described herein. In FIGS. 1-2, only one such computer device is shown purely for convenience purposes. One of ordinary skill in the art would understand at the time of filing of this application that the computer functions relating to the service as described herein may be implemented in a distributed fashion on a number of similar platforms, to distribute the processing load.

The computing apparatus 200, for example, may include COM ports 250 connected to and from a network connected thereto to facilitate data communications. The computing apparatus 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing apparatus may include the internal communication bus 210, program storage and data storage of different forms including, for example, a disk 270, and a read only memory (ROM) 230, or a random access memory (RAM) 240, for various data files to be processed and/or transmitted by the computing apparatus. The exemplary computing apparatus may also include program instructions stored in the ROM 230, RAM 240, and/or another type of non-transitory storage medium to be executed by the processor 220. The methods and/or processes of the present disclosure may be implemented as the program instructions. The computing apparatus 200 also includes an I/O component 260, supporting input/output between the computer and other components. The computing apparatus 200 may also receive programming and data via network communications.

Merely for illustration, only one processor and/or processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing apparatus 200 executes both operation A and operation B, it should be understood that operation A and operation B may also be performed by two different CPUs and/or processors jointly or separately in the computing apparatus 200 (e.g., the first processor executes operation A and the second processor executes operation B, or the first and second processors jointly execute operations A and B).

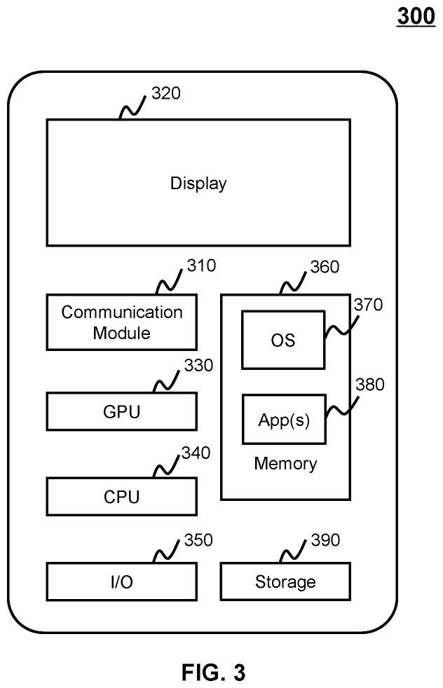

FIG. 3 is a block diagram illustrating exemplary hardware and/or software components of an exemplary mobile device according to some embodiments of the present disclosure. The user terminal 130 or the driver device 140 may be implemented on the mobile device 300 according to some embodiments of the present disclosure. As illustrated in FIG. 3, the mobile device 300 may include a communication module 310, a display 320, a graphic processing unit (GPU) 330, a central processing unit (CPU) 340, an I/O 350, a memory 360, and a storage 390. The CPU 340 may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to a service request or other information from the transportation recommendation system on the mobile device 300. User interactions with the information stream may be achieved via the I/O devices 350 and provided to the processing device 112 and/or other components of the travel service recommendation system 100 via the network 150.

In order to implement various modules, units and their functions described above, a computer hardware platform may be used as hardware platforms of one or more elements (e.g., a component of the server 110 described in FIG. 1). Since these hardware elements, operating systems, and program languages are common, it may be assumed that persons skilled in the art may be familiar with these techniques and they may be able to provide information required in the data classification according to the techniques described in the present disclosure. A computer with a user interface may be used as a personal computer (PC), or other types of workstations or terminal devices. After being properly programmed, a computer with a user interface may be used as a server. It may be considered that those skilled in the art may also be familiar with such structures, programs, or general operations of this type of computer device. Thus, additional explanations are not described for the figures.

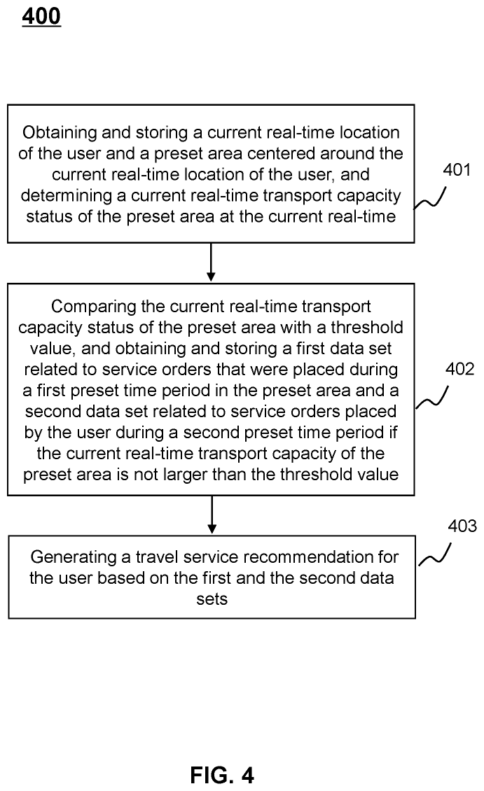

FIG. 4 is a flowchart illustrating a process 400 for recommending travel services to a user according to some embodiments of the present disclosure. In some embodiments, the process 400 shown in FIG. 4 may be implemented in the travel service recommendation system 100 illustrated in FIG. 1. For example, at least a part of the process 400 may be stored in a storage device (e.g., the DISK 270 of the computing apparatus 200) as a form of instructions, and invoked and/or executed by the server 110 (e.g., the processor 220 of the computing apparatus 200). In some embodiments, a part of the process 400 may be implemented on a terminal device. The operations of the illustrated process 400 presented below are intended to be illustrative. In some embodiments, the process 400 may be accomplished with one or more additional operations not described, and/or without one or more of the operations discussed. Additionally, the order in which the operations of the process 400 as illustrated in FIG. 4 and described below is not intended to be limiting.

In 401, the server 110 may obtain a current real-time location of the user and a preset area centered around the current real-time location of the user, and determine a current real-time transport capacity status of the preset area at the current real-time.

As used herein, the transport capacity status refers to information related to number of service requests placed and available service providers in the preset area centered around the current real-time location of the user. In some embodiments, the transport capacity status of the preset area may be determined according to the number of service requests placed by users in the preset area (also referred to as “service requests placed”) and the number of available service providers in the preset area. The current real-time transport capacity status refers to a transportation capacity status at the current real-time. Similarly, the current real-time transport capacity status of the preset area may be determined according to the number of service requests placed to the number of available service providers in the preset area at the current real-time.

The current real-time location (also referred to as “current location” for brevity) of the user refers to a geographic location where the user is located currently. The server may obtain the current location of the user when the user activates a car-hailing app. The car-hailing app may be installed on a mobile terminal such as a smartphone, a personal digital assistant (PDA), or the like. It should be noted that the present disclosure may not be limited to examples of the embodiments described herein.

In some embodiments, the server 110 may obtain the current real-time location of the user from the positioning device 160. The positioning device 160 may determine the current real-time location of the user terminal 130. In some embodiments, the positioning device 160 may be or connect with a global positioning system (GPS), a global navigation satellite system (GLONASS), a compass navigation system (COMPASS), a BeiDou navigation satellite system, a Galileo positioning system, a quasi-zenith satellite system (QZSS), etc.

Merely for illustration purposes, the car-hailing app may obtain the current location of the user using global positioning system (GPS), and send the current location to the server 110. In some embodiments, the server 110 may determine the current location of the user based on information of GPS installed on the user terminal 130.

Furthermore, the server 110 may obtain the transport capacity status of the preset area centered around the current location of the user. In some embodiments, the transport capacity status of the preset area centering around the current location of the user refers to the information of number of service requests and available service providers in the preset area centering around current location of the user. For example, the server 110 may obtain information of number of service requests and available service providers in a preset area with a radius of 3 kilometers centering around the current location of the user after the server 110 obtains the current location of the user. The number of service requests refers to the number of service requests placed by the user. The number of available service providers refers to the number of vehicles that provides travel services. In some embodiments, the transport capacity status of the preset area centering around the current location of the user may be represented as a ratio of number of service requests placed to number of available service providers in the preset area centering around the current location of the user. In some embodiments, the transport capacity status of the preset area centering around the current location of the user may be represented as a difference between the number of service requests placed and the number of available service providers in the preset area centering around the current location of the user. It should be noted that the preset area centering around the current location of the user may have different radiuses, such as 2 kilometers, 4 kilometers, or the like. In some embodiments, the preset area may be set according to actual requirements, which is not limited in the present disclosure.

In some embodiments, when the user activates the car-hailing app, the server 110 may verify the identity of the user before the current location of the user is obtained. Specifically, the server 110 may receive verification information such as a verification code, a fingerprint, a password, etc., sent by the user terminal 130, and verify the verification information. The server 110 may return response information to the user terminal 130 after the verification information is verified, and the user terminal 130 may request a car-hailing service upon the reception of the response information.

In 402, the server 110 may compare the current real-time transport capacity status of the preset area with a threshold value, and obtain a first data set related to service orders that were placed in a first preset time period in the preset area and a second data set related to service orders placed by the user in a second preset time period if the current real-time transport capacity of the preset area is not larger than the threshold value.

The transport capacity status may indicate both available transport capacity in the preset area and whether the number of service requests and available service providers in the preset area are in equilibrium. The transport capacity status may serve as a reference for dispatching orders.

The server 110 may compare the current real-time transport capacity status of the preset area with a threshold value. The threshold value may be used to determine whether a balance between service supply and service demand is achieved. In some embodiments, the threshold value may be set by a user, according to default settings of the travel service recommendation system 100.

Specifically, if the transport capacity status of the preset area is not larger than the threshold value, a first data set related to service orders that were placed during a first preset time period in the preset area and a second data set related to service orders placed by the user during a second preset time period may be obtained. The first data set may be order information of the service orders that were placed by multiple users during the first preset time period in the preset area. The first preset time period may be defined by a user, according to default settings of the travel service recommendation system 100. For example, the first preset time period may be two weeks, one month, half a year, etc. The second data set may be order information of the service orders that were placed by the user during a second preset time period. The second data set may include at least one of pick up location, departure time, trip duration, destination location, or travel mode of each service order. The second preset time period may be defined by a user, according to default settings of the travel service recommendation system 100. For example, the second preset time period may be two weeks, one month, half a year, etc. In some embodiments, the first preset time period and the second preset time period may at least partially overlap with each other. In some embodiments, the first preset time period and the second preset time period may not overlap with each other. In some embodiments, the first data set and/or the second data set may be stored in a storage device (e.g., the storage device 150) of the travel service recommendation system 100 capable of storing data.

In 403, the server 110 may generate a travel service recommendation for the user based on the first and the second data sets.

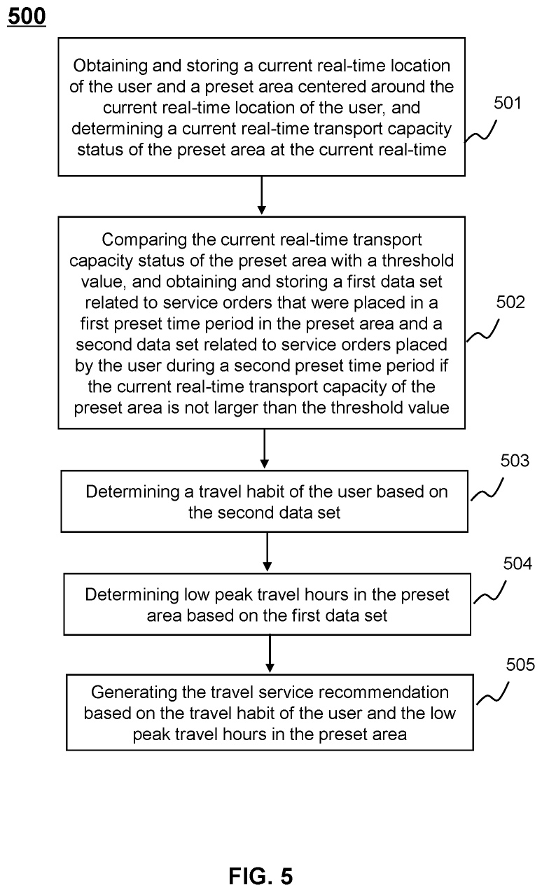

The travel service recommendation refers to a recommendation of travel mode (e.g., taxi service, carpooling service, express service, etc.), departure time, start location, travelling route, or the like, or a combination thereof. The travel service recommendation may be generated based on the first and the second data sets. In some embodiments, the travel service recommendation for the user may also provide a discount for the user. Details regarding the travel service recommendation may be described elsewhere in the present disclosure, for example, FIG. 5 and the descriptions thereof.

According to the method described in the process 400, a current real-time location of the user and a preset area centered around the current real-time location of the user may be obtained, and a current real-time transport capacity status of the preset area at the current real-time may be determined. If the current real-time transport capacity of the preset area is not larger than a threshold value, a first data set related to service orders that were placed during a first preset time period in the preset area and a second data set related to service orders placed by the user during a second preset time period may be obtained. A travel service recommendation for the user may be generated based on the first and the second data sets. The method provides travel service recommendation for the user so as to enable the user to adjust his/her travelling time actively in consideration of transport capacity status actively, thus improving the flexibility of transportation capacity scheduling.

It should be noted that the above description is merely provided for the purposes of illustration, and not intended to limit the scope of the present disclosure. For persons having ordinary skills in the art, multiple variations and modifications may be made under the teachings of the present disclosure. For example, the server 110 may further transmit the travel service recommendation to a user interface of a terminal device of the user for display. However, those variations and modifications do not depart from the scope of the present disclosure.

FIG. 5 is a flowchart illustrating a process 500 for recommending travel services to a user according to some embodiments of the present disclosure. In some embodiments, the process 500 shown in FIG. 5 may be implemented in the travel service recommendation system 100 illustrated in FIG. 1. For example, at least a part of the process 500 may be stored in a storage device (e.g., the DISK 270 of the computing apparatus 200) as a form of instructions, and invoked and/or executed by the server 110 (e.g., the processor 220 of the computing apparatus 200). Additionally, the order in which the operations of the process 500 as illustrated in FIG. 5 and described below is not intended to be limiting.

In 501, the server 110 may obtain a current real-time location of the user and a preset area centered around the current real-time location of the user, and determine a current real-time transport capacity status of the preset area at the current real-time. The operations in 501 may be the same as or similar to the operations in 401 in the process 400.

In 502, the server 110 may compare the current real-time transport capacity status of the preset area with a threshold value, and obtain a first data set related to service orders that were placed in a first preset time period in the preset area and a second data set related to service orders placed by the user in a second preset time period if the current real-time transport capacity of the preset area is not larger than the threshold value.

The first data set may be order information of the service orders that were placed by multiple users during the first preset time period in the preset area. The second data set may be order information of the service orders that were placed by the user during a second preset time period. The second data set may include pick up location, departure time, trip duration, destination, or travel mode of each service order.

The transport capacity status of the preset area may be determined based on the threshold value and number of service requests placed and available service providers in the preset area obtained in 501. In some embodiments, the number of service requests and available service providers in the preset area may be obtained, and the transport capacity status of the preset area may be calculated. Merely by ways of example, the calculation result may include a ratio of the number of service requests to the number of available service providers, a difference between the number of service requests and the number of available service providers, or the like. The calculation result may be used to represent the transport capacity status of the vehicle in the preset area. The calculation of the transport capacity status of the vehicle in the preset area may be realized using various methods according to the actual situation, which is not limited in the present disclosure.

In some embodiments, the transport capacity status of the preset area may be determined by calculating a ratio of the number of service requests placed and the number of available service providers in the preset area obtained in 501. The ratio may be compared with the threshold value.

In some embodiments, if the ratio of the number of service requests placed to the number of available service providers in the preset area is less than or equal to the threshold value, the server 110 may determine that the transport capacity status of the current preset area is sufficient. If the ratio of the number of service requests placed and the number of available service providers in the preset area is greater than the threshold value, the server 110 may determine that the transport capacity status of the current preset area is insufficient. For example, if the number of service requests placed in the preset area is 50 and the number of available service providers in the preset area is 25, the ratio of the number of service requests placed and the number of available service providers in the preset area is 2. If the threshold value is set as 1, the server 110 may determine that the transport capacity status of the preset area is insufficient.

In some embodiments, a ratio of the number of available service providers and the number of service requests placed in the preset area may be determined. If the ratio of the number of available service providers and the number of service requests placed in the preset area is greater than or equal to the threshold value, the server 110 may determine that the transport capacity status of the preset area is sufficient. If the ratio of the number of available service providers and the number of service requests placed in the preset area is smaller than the threshold value, the server 110 may determine that the transport capacity status of the current preset area is insufficient. For example, if the number of service requests placed in the preset area is 50 and the number of available service providers in the preset area is 25, the ratio of the number of available service providers and the number of service requests placed in the preset area is 0.5. If the threshold value is 1, the server 110 may determine that the transport capacity status of the preset area is insufficient.

The server 110 may obtain a first data set related to service orders that were placed in a first preset time period in the preset area and a second data set related to service orders placed by the user during a second preset time period if the current transport capacity status of the preset area is insufficient. In some embodiments, the first data set may be order information of the service orders that were placed by multiple users during the first preset time period in the preset area. The second data set may be order information of the service orders that were placed by the user during a second preset time period. The second data set may include pick-up location (i.e., start location), departure time, trip duration, destination (i.e., end location), or travel mode of each service order. The travelling mode of each service order may include an express service, a carpooling service, a taxi service, etc.

The first data set and/or the second data set may be stored in the server 110. When the transport capacity status in the preset area is insufficient, the server 110 may obtain the pick-up location, the destination, the travel mode, and the departure time of all orders placed within 60 days by users in the preset area, and the pick-up location, the destination, the travel mode, and the departure time of all orders placed within 60 days by the user.

In some embodiments, the service orders related to the first data set may be placed in a first time period, and the service orders related to the second data set may be placed in a second time period. The first time period and the second time period may be the same or different. In some embodiments, the first preset time period and the second preset time period may at least partially overlap with each other. In some embodiments, the first preset time period and the second preset time period may not overlap with each other. In some embodiments, the first time period and/or the second time period may be set according to actual requirements, which is not limited in the present disclosure. The longer the first time period and/or the second time period are, the larger the data volume of the first and second data sets will be, and the accuracy of the result obtained by processing the first and set data sets may be higher. It should be noted that an order may be generated according to a service request of the user if the current real-time transport capacity status of the preset area is sufficient.

In 503, the server 110 may determine a travel habit of the user based on the second data set. The travel habit may represent an itinerary of the user with a highest frequency of travel or routine itineraries of the user during the second time period.

In some embodiments, the server 110 may obtain and analyze the pick-up location, the destination, the travel mode, and the departure time of each service order in the second data set to determine the travel habit of the user. In some embodiments, the travel habit of the user may include at least one of an itinerary of the user with a highest frequency of travel or routine itineraries of the user during the second preset time period. The server 110 may determine the pick-up location, the destination, the travel mode, and the departure time of an itinerary of the user with a highest frequency of travel and/or routine itineraries of the user during the second time period.

In 504, the server 110 may determining low peak travel hours in the preset area based on the first data set.

In some embodiments, the server 110 may analyze transport capacity status of each of a plurality of time node during the first time period in the preset area centering around the current location of the user according to the first data set, so as to determine low peak travel hours in the preset area. Time periods with sufficient transport capacity status during the first time period may be determined as low peak travel hours. In some embodiments, transport capacity status of each time node during the first time period in the preset area may be determined according to the number of service requests placed and available service providers at each time node.

In 505, the server 110 may generate the travel service recommendation based on the travel habit of the user and the low peak travel hours in the preset area.

In some embodiments, the server 110 may generate the travel service recommendation for the user based on the low peak travel hours in the preset area and the departure location, the destination, the travel mode, and the departure time of the itinerary of the user with a highest frequency of travel and/or routine itineraries of the user during the second time period. The travel service recommendation may provide users with better travel services, enhance the users' travel experience, as well as allocate surplus transport capacity actively.

In some embodiments, the travel service recommendation for the user may include a discount that can be applied in a travel service order when the travel habit of the user matches the low peak travel hours in the preset area. In some embodiments, the travel service recommendation may be applied during the low peak hours within the preset area, and include a discount that can be applied to an itinerary of a same departure location, a same destination, and a same travel mode as those of the itinerary of the user with a highest frequency and/or routine itineraries of the user.

In some embodiments, the travel service recommendation for the user may include a discount that can be applied in a travel service order when a currently requested itinerary of the user matches the low peak travel hours. In some embodiments, the travel service recommendation may be applied during the low peak hours within the preset area. The travel service recommendation may be or include a discount that can be applied to an itinerary of a same departure location, a same destination, and a same travel mode as that of the currently requested itinerary of the user.

In some embodiments, the travel service recommendation for the user may include a recommended new pick-up location that is in a preset range from the currently requested pick-up location of the user when a transport capacity status of a new preset area centering around the recommended new pick-up location satisfies a preset condition. The preset condition may be that the transport capacity status of the new preset area centering around the recommended new pick up location is larger than the threshold value. In some embodiments, the recommended new pick-up location may be in a preset range from the currently requested pick-up location of the user, and the destination may be the same as that of the current itinerary of the user, and the travel mode may be the same as that used in the current itinerary of the user. The transport new pick-up location is larger than the threshold value. In another word, the discount may be applied during the low peak hours within the new preset area centering around the recommended new pick up location.

It should be noted that the travel service recommendation for the user may also include other information, which is not limited in the present disclosure.

In some embodiments, the method in the process 500 may include Obtaining and storing a current real-time location of the user and a preset area centered around the current real-time location of the user, and determining a current real-time transport capacity status of the preset area at the current real-time; comparing the current real-time transport capacity status of the preset area with a threshold value, and obtaining and storing a first data set related to service orders that were placed in a first preset time period in the preset area and a second data set related to service orders placed by the user during a second preset time period if the current real-time transport capacity of the preset area is not larger than the threshold value; determining a travel habit of the user based on the second data set; determining low peak travel hours in the preset area based on the first data set; and generating the travel service recommendation based on the travel habit of the user and the low peak travel hours in the preset area. The above method may determine travel habit of the user based on information such as pick-up location, destination, travel mode and departure time in historical orders, generate the travel service recommendation to enable the user to adjust the travelling time actively, deploy the transport capacity actively, improve the flexibility of the deployment, as well as enhance user experience by analyzing the travel habit of the user.

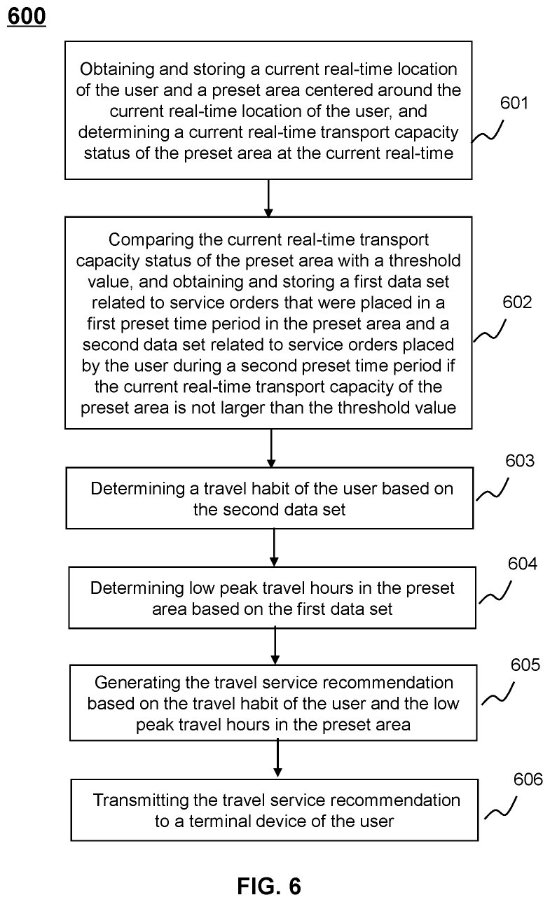

FIG. 6 is a flowchart illustrating a process 600 for recommending travel services to a user according to some embodiments of the present disclosure. As shown in FIG. 6, the process 600 may further include an operation 606 for transmitting the travel service recommendation to a terminal device of the user in comparison with the process 500. The operations 601 through 605 may be similar to or the same as the operations 501 through 505 in the process 500.

In 606, the server 110 may transmit the travel service recommendation to a terminal device of the user.

The server 110 may transmit one or more travel service recommendations to the user terminal 130. The one or more travel service recommendations may enable the user to select suitable pick-up location, destination, travel mode, and departure time.

Merely for illustration purposes, the server 110 may obtain a current location of the user, and current real-time transport capacity status within a range of 3 km centering around the current location of the user when the user initiates the car-hailing app on his/her mobile terminal, obtain and analyze order information of service orders placed within the last 60 days by the user, determine that the user uses an express service to travel from location A to location B at 2 p.m. every Saturday based on the order information, and obtain and analyze order information of service orders placed within 60 days by all users in a range of 3 km centering around the location A, determine that 2 p.m. is within high peak travel hours and 12 a.m. to 1 p.m. is within low peak travel hours. Therefore, a discount for express service with twenty percent off may be recommended to the user for travelling from location A to the location B between 12 a.m. to 1 p.m. on Saturday.

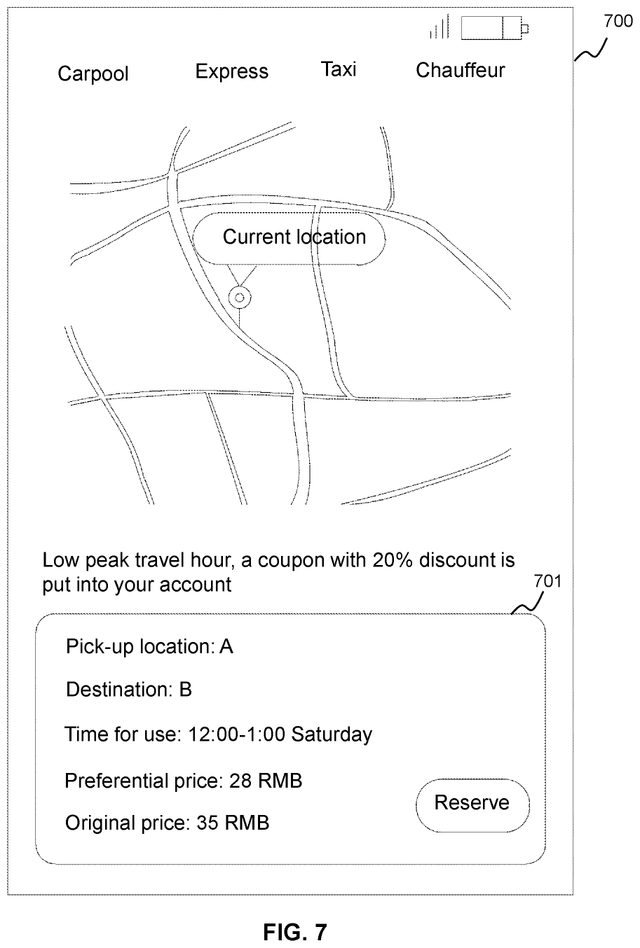

FIG. 7 is a schematic diagram illustrating an exemplary user interface displaying a travel service recommendation of a discount which can be applied in a service order according to some embodiment of the present disclosure. As shown in FIG. 7, a coupon 701 with the discount may be displayed in the user interface 700 of a mobile terminal, and a button “reserve” is provided to enable the user to access, from the current interface to a service reserving interface for reserving travel services directly, which may reduce the time spent on switching to a corresponding interface manually. The user interface 700 of the mobile terminal may switch to the service reserving interface if the user clicks the button “reserve”. The discount can be applied when the user obtains the coupon and reserves a recommended travel service between 12 a.m. to 1 p.m. on Saturday.

The user interface 700 may show a current location of the user, and available travel services at the current location. The user interface 700 may provide a coupon 701 to the user as a travel service recommendation generated based on travel habit of the user and low peak travel hours in a preset area centering around the current location of the user. The coupon 701 may include information of pick-up location, destination, time for use the coupon, preferential price, original price. The preferential price may be determined by multiplying the original price by the discount.

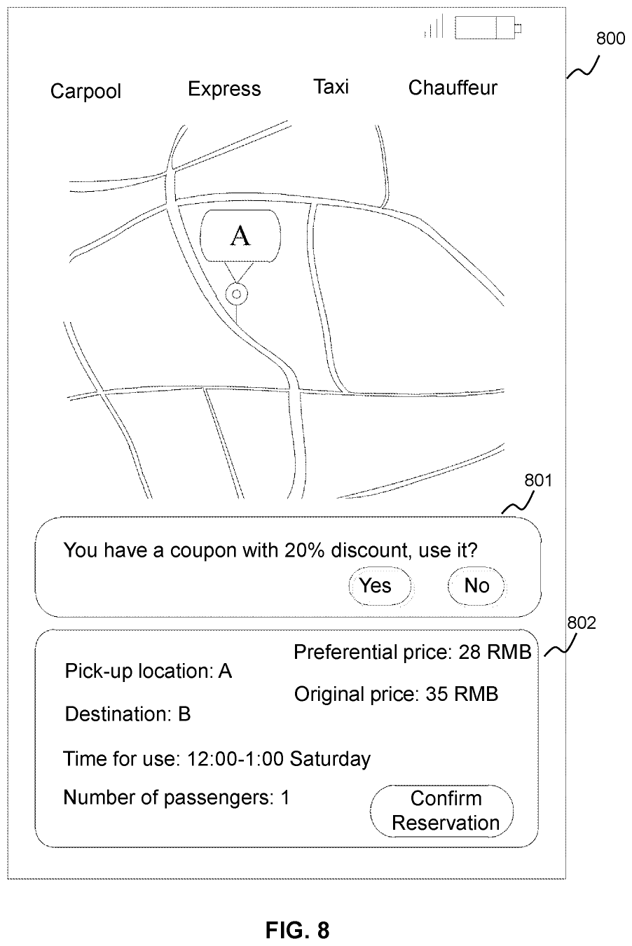

FIG. 8 is a schematic diagram illustrating an exemplary user interface for reserving a travel service in which a discount can be applied according to some embodiment of the present disclosure. As shown in FIG. 8, the user interface 800 on a mobile terminal may display an information box 801 prompting that the user has a coupon 802 with 20% discount, and whether the user chooses to use the coupon 802 in the reserved service order. A preferential price and an original price may be displayed as a reference when the user reserves a travel service. The user may select whether to reserve a travel service according to his/her requirements. A service order may be generated if the user clicks the “confirm reservation” button. It should be noted that the user interface 800 displayed on the terminal may also include other information, which is not limited in the present disclosure.

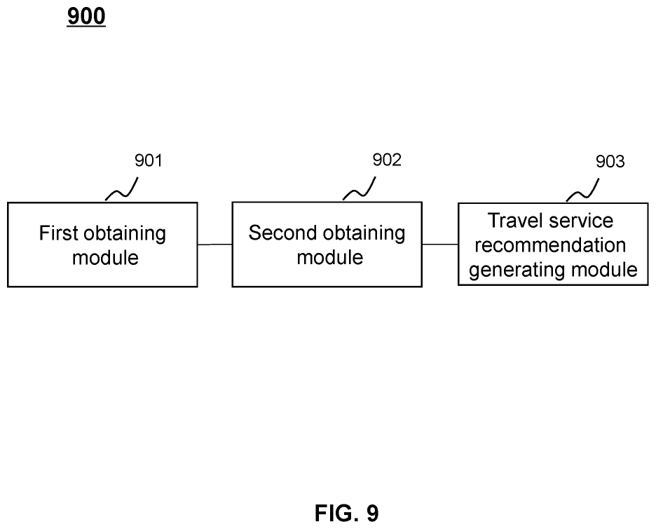

FIG. 9 is a schematic diagram illustrating an exemplary travel service recommendation device for recommending travel services for a user according to some embodiment of the present disclosure. The travel service recommendation device 900 may be used to implement the methods described in the process 400-600 in FIGS. 4-6. As shown in FIG. 9, the travel service recommendation device 900 may include a first obtaining module 901, a second obtaining module 902, and a travel service recommendation generating module 903.

The first obtaining module 901 may be configured to obtain a current real-time location of the user and a preset area centering around the current real-time location of the user, and determine a current real-time transport capacity status of the preset area at the current real-time. The transport capacity status refers to information related to number of service requests placed and available service providers in the preset area centered around the current real-time location of the user. In some embodiments, the transport capacity status of the preset area may be determined according to the number of service requests placed by users in the preset area and the number of available service providers in the preset area.

The first obtaining module 901 may obtain the current real-time location of the user from the positioning device 160. Merely for illustration purposes, the car-hailing app may obtain the current location of the user using global positioning system (GPS), and send the current location to the first obtaining module 901.

In some embodiments, the transport capacity status of the preset area centering around the current location of the user may be represented as a ratio of number of service requests placed to number of available service providers in the preset area centering around the current location of the user. In some embodiments, the transport capacity status of the preset area centering around the current location of the user may be represented as a difference between the number of service requests placed and the number of available service providers in the preset area centering around the current location of the user.

The second obtaining module 902 may be configured to compare the current real-time transport capacity status of the preset area with a threshold value, and obtain a first data set related to service orders that were placed during a first preset time period in the preset area and a second data set related to service orders placed by the user during a second preset time period if the current real-time transport capacity of the preset area is not larger than the threshold value.

The second obtaining module 902 may compare the current real-time transport capacity status of the preset area with a threshold value. The threshold value may be used to determine whether a balance between service supply and service demand is achieved.

Specifically, if the transport capacity status of the preset area is not larger than the threshold value, a first data set related to service orders that were placed during a first preset time period in the preset area and a second data set related to service orders placed by the user during a second preset time period may be obtained. The first data set may be order information of the service orders that were placed by multiple users during the first preset time period in the preset area. The second data set may be order information of the service orders that were placed by the user during a second preset time period. The second data set may include at least one of pick up location, departure time, trip duration, destination location, or travel mode of each service order.

The travel service recommendation generating module 903 may be configured to generate a travel service recommendation for the user based on the first and the second data sets.

In some embodiments, the travel service recommendation for the user may include a discount that can be applied in a travel service order when the travel habit of the user matches the low peak travel hours in the preset area. In some embodiments, the travel service recommendation may be applied during the low peak hours within the preset area, and include a discount that can be applied to an itinerary of a same departure location, a same destination, and a same travel mode as those of the itinerary of the user with a highest frequency and/or routine itineraries of the user.

In some embodiments, the travel service recommendation for the user may include a discount that can be applied in a travel service order when a currently requested itinerary of the user matches the low peak travel hours. In some embodiments, the travel service recommendation may be applied during the low peak hours within the preset area. The travel service recommendation may be or include a discount that can be applied to an itinerary of a same departure location, a same destination, and a same travel mode as that of the currently requested itinerary of the user.

In some embodiments, the travel service recommendation for the user may include a recommended new pick-up location that is in a preset range from the currently requested pick-up location of the user when a transport capacity status of a new preset area centering around the recommended new pick-up location satisfies a preset condition. The preset condition may be that the transport capacity status of the new preset area centering around the recommended new pick up location is larger than the threshold value. In some embodiments, the recommended new pick-up location may be in a preset range from the currently requested pick-up location of the user, and the destination may be the same as that of the current itinerary of the user, and the travel mode may be the same as that used in the current itinerary of the user. The transport capacity status of a new preset area centering around the new pick-up location is larger than the threshold value. In another word, the discount may be applied during the low peak hours within the new preset area centering around the recommended new pick up location.

In some embodiments, the travel service recommendation device 900 may obtain a current real-time location of the user and a preset area centering around the current real-time location of the user, and determine a current real-time transport capacity status of the preset area at the current real-time; compare the current real-time transport capacity status of the preset area with a threshold value, and obtain a first data set related to service orders that were placed during a first preset time period in the preset area and a second data set related to service orders placed by the user during a second preset time period if the current real-time transport capacity of the preset area is not larger than the threshold value; and generate a travel service recommendation for the user based on the first and the second data sets. The travel service recommendation device 900 may provide travel service recommendation for the user so as to enable the user to adjust his/her travelling time actively in consideration of transport capacity status actively, thus improving the flexibility of transportation capacity scheduling.

In some embodiments, the second obtaining module 902 may be configured to obtain pick-up location, departure time, trip duration, destination location, or travel mode of each service order placed during the second time period by the user.

In some embodiments, the generating module 903 may be configured to determine a travel habit of the user based on the second data set. The travel habit may represent an itinerary of the user with a highest frequency of travel or routine itineraries of the user during the second time period.

The generating module 903 may determine low peak travel hours in the preset area based on the first data set, and generate the travel service recommendation based on the travel habit of the user and the low peak travel hours in the preset area.

In some embodiments, the travel service recommendation may include a discount that can be applied in a travel service order when the travel habit of the user matches the low peak travel hours in the preset area, a discount that can be applied in a travel service order when a currently requested itinerary of the user matches the low peak travel hours, or a recommended new pick-up location that is in a preset range from the currently requested pick-up location of the user when a transport capacity status of a new preset area centering around the recommended new pick-up location satisfies a preset condition. The transport capacity status of a new preset area centering around the new pick-up location is larger than the threshold value.

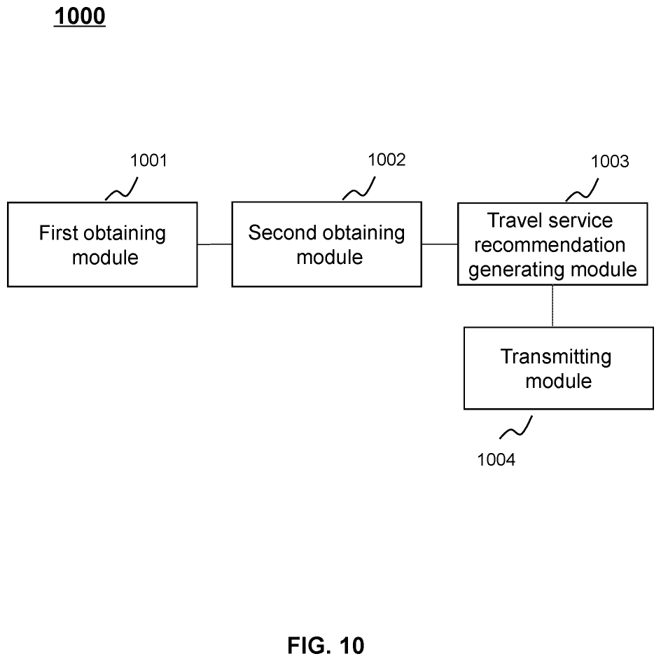

FIG. 10 is a schematic diagram illustrating an exemplary travel service recommendation device for recommending travel services for a user according to some embodiment of the present disclosure. As shown in FIG. 10, the travel service recommendation device may further include a transmitting module 1004 in comparison with FIG. 9. The modules 1001-1003 may be similar to or the same as the modules 901-903 illustrated in FIG. 9.

The transmitting module 1004 may be configured to transmit one or more travel service recommendations to the user terminal 130. The one or more travel service recommendations may enable the user to select suitable pick-up location, destination, travel mode, and departure time.

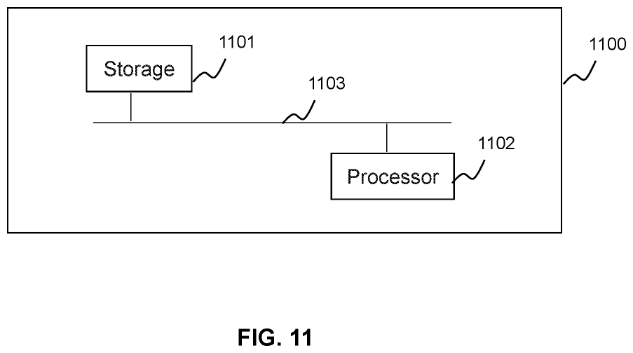

FIG. 11 is a schematic diagram illustrating an exemplary device for recommending travel services for a user according to some embodiments of the present disclosure. As shown in FIG. 11, the device 1100 may include a storage 1101 and a processor 1102.

The storage 1101 may be a separate physical component connected to the processor 1002 via the bus 1003. The storage 1101 and the processor 1002 may also be integrated together.

The storage 1101 may be configured to store the above methods and/or embodiments in forms of computer programs. The processor 1002 may execute a computer program to implement the above methods.

The processor 1102 may include a central processing unit (CPU), a network processor (NP), or a combination of the CPU and the NP.

The processor 1102 may further include a hardware chip. The hardware chip may include an Application-Specific Integrated Circuit (ASIC), a Programmable Logic Device (PLD), or a combination thereof. The PLD may include a Complex Programmable Logic Device (CPLD), a Field-Programmable Gate Array (FPGA), a Generic Array Logic (GAL), or any combination thereof.

The storage 1101 may include a Volatile Memory, a Non-volatile Memory, or a combination thereof. The Volatile Memory may include a Random-Access Memory (RAM). The Non-volatile Memory may include a flash memory, a hard disk drive (HDD) or a solid state drive (SSD).

The present disclosure provides a device for recommending travel services for the user which includes at least one processer (or chip) for executing the above methods.

Further, the present disclosure provides a computer readable storage medium for storing a program. When the computer program is executed by a processer, one or more steps in the above methods may be realized.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

1. A method implemented on a device having a processor and a computer-readable storage medium for recommending travel services to a user, the method comprising:
obtaining and storing in the device, a current real-time location of the user and a preset area centered around the current real-time location of the user;
determining and storing in the device, a current real-time transport capacity status of the preset area at the current real-time;
using the processor to compare the current real-time transport capacity status of the preset area with a threshold value;
if the current real-time transport capacity status of the preset area is not larger than the threshold value, obtaining and storing in the device, a first data set related to service orders that were placed in a first preset time period in the preset area and a second data set related to service orders placed by the user during a second preset time period and
using the processor to generate a travel service recommendation for the user based on the first and the second data sets.

2. The method of claim 1, further comprising transmitting the travel service recommendation to a terminal device of the user.

3. The method of claim 1, wherein the second data set comprises at least one of pick up location, departure time, trip duration, destination location, or travel mode of each service order.

4. The method of claim 1, wherein the first preset time period and the second preset time period at least partially overlap with each other.

5. The method of claim 1, wherein the first preset time period and the second preset time period do not overlap with each other.

6. The method of claim 1, wherein the current real-time transport capacity status of the preset area is determined according to a ratio of the number of service requests placed to the number of available service providers in the preset area at the current real-time or a difference between the number of service requests placed and the number of available service providers in the preset area at the current real-time.

7. The method of claim 1, wherein generating the travel service recommendation based on the first and the second data sets comprising:
determining a travel habit of the user based on the second data set;
determining low peak travel hours in the preset area based on the first data set; and
generating the travel service recommendation based on the travel habit of the user and the low peak travel hours in the preset area.

8. The method of claim 7, wherein the travel habit of the user comprises at least one of an itinerary of the user with a highest frequency of travel or routine itineraries of the user during the second preset time period.

9. The method of claim 7, wherein the travel service recommendation comprises at least one of
a discount when the travel habit of the user matches the low peak travel hours in the preset area,
a discount when a currently requested itinerary of the user matches the low peak travel hours, or
a recommended new pick up location that is in a preset range from the currently requested pick up location of the user when a transport capacity status of a new preset area centering around the recommended new pick up location satisfies a preset condition.

10. The method of claim 1, further including:
providing a user interface for reserving a travel service in which the discount can be applied based on the travel service recommendation.

11. A system for recommending travel services to a user, comprising:
at least one storage medium including a set of instructions; and
at least one processor configured to communicate with the at least one storage medium, wherein when executing the set of instructions, the at least one processor is directed to:
obtain and store in the storage medium, a current real-time location of the user and a preset area centered around the current real-time location of the user;
determine and store in the storage medium, a current real-time transport capacity status of the preset area at the current real-time;
use the at least one processor to compare the current real-time transport capacity status of the preset area with a threshold value;
if the current real-time transport capacity status of the preset area is not larger than the threshold value, obtain and store in the storage medium, a first data set related to service orders that were placed in a first preset time period in the preset area and a second data set related to service orders placed by the user during a second preset time period and
use the at least one processor to generate a travel service recommendation for the user based on the first and the second data sets.

12. The system of claim 11, the at least one processor is further directed to:
transmit the travel service recommendation to a terminal device of the user.

13. The system of claim 11, wherein the second data set comprises at least one of pick up location, departure time, trip duration, destination location, or travel mode of each service order.

14. The system of claim 11, wherein the first preset time period and the second preset time period at least partially overlap with each other.

15. The system of claim 11, wherein the first preset time period and the second preset time period do not overlap with each other.

16. The system of claim 11, wherein the current real-time transport capacity status of the preset area is determined according to a ratio of the number of service requests placed to the number of available service providers in the preset area at the current real-time or a difference between the number of service requests placed and the number of available service providers in the preset area at the current real-time.

17. The system of claim 11, wherein to generate the travel service recommendation based on the first and the second data sets, the at least one processor is directed to:
determine a travel habit of the user based on the second data set;
determine low peak travel hours in the preset area based on the first data set; and
generate the travel service recommendation based on the travel habit of the user and the low peak travel hours in the preset area.

18. The system of claim 17, wherein the travel habit of the user comprises at least one of an itinerary of the user with a highest frequency of travel or routine itineraries of the user during the second preset time period.

19. The system of claim 17, wherein the travel service recommendation comprises at least one of
a discount when the travel habit of the user matches the low peak travel hours in the preset area,
a discount when a currently requested itinerary of the user matches the low peak travel hours, or
a recommended new pick up location that is in a preset range from the currently requested pick up location of the user when a transport capacity status of a new preset area centering around the recommended new pick up location satisfies a preset condition.

20. A non-transitory computer readable medium, comprising at least one set of instructions for recommending travel services to a user, wherein when executed by at least one processor of a computing device, the at least one set of instructions causes the computing device to perform a method, the method comprising:
obtaining and storing in the device, a current real-time location of the user and a preset area centered around the current real-time location of the user;
determining and storing in the device, a current real-time transport capacity status of the preset area at the current real-time;
using the processor to compare the current real-time transport capacity status of the preset area with a threshold value;
if the current real-time transport capacity status of the preset area is not larger than the threshold value, obtaining and storing in the device, a first data set related to service orders that were placed in a first preset time period in the preset area and a second data set related to service orders placed by the user during a second preset time period and
using the processor to generate a travel service recommendation for the user based on the first and the second data sets.
